(19) United States
(12) Patent Application Publication
(10) Pub. No.: US 2009/0315980 A1
(43) Pub. Date: Dec. 24, 2009

(54) IMAGE PROCESSING METHOD AND APPARATUS

(75) Inventors: Kil-soo JUNG, Osan-si (KR); Hyun-kwon Chung, Seoul (KR); Dae-jong Lee, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co.,, Suwon-si (KR)

(21) Appl. No.: 12/489,749

(22) Filed: Jun. 23, 2009

Related U.S. Application Data
(60) Provisional application No. 61/075,184, filed on Jun. 24, 2008.

(30) Foreign Application Priority Data
Sep. 26, 2008 (KR) 10-2008-0094896

(51) Int. Cl. H04N 13/00

(52) U.S. Cl. 348/43; 348/42; 348/E13.001

(57) ABSTRACT

An image processing method including outputting a predetermined region of one or more frames of video data as a two-dimensional (2D) image and other regions of the one or more frames as a three-dimensional (3D) image by using meta data of the video data, where the meta data includes information to classify the frames into predetermined units.

### CROSS-REFERENCE TO RELATED APPLICATIONS

This application claims the benefit of U.S. Provisional Application No. 61/075,184, filed on Jun. 24, 2008, in the U.S. Patent and Trademark Office, and the benefit of Korean Patent Application No. 10-2008-0094896, filed on Sep. 26, 2008 in the Korean Intellectual Property Office, the disclosures of which are incorporated herein in their entirety by reference.

### BACKGROUND OF THE INVENTION

1. Field of the Invention

Aspects of the present invention relate to an image processing method and apparatus, and more particularly, to an image processing method and apparatus to generate a depth map regarding an object by using depth information for a background that is extracted from meta data of video data.

2. Description of the Related Art

Advances in digital technology have led to wide spread use of three-dimensional (3D) image technology. The 3D image technology assigns information regarding depth to a two-dimensional (2D) image, thereby expressing a more realistic image. Human eyes are spaced a predetermined distance apart in the horizontal direction, such that a 2D image seen with a left eye is different from that seen with a right eye. Such a phenomenon is referred to as a binocular parallax. Thus, the human brain combines the two different 2D images to generate a 3D image having depth and reality.

The 3D image technology is classified into a technique to directly convert video data into a 3D image and a technique to convert a 2D image into a 3D image. Recently, research has been conducted into both of these techniques.

### SUMMARY OF THE INVENTION

Aspects of the present invention provide an image processing method and apparatus to output a predetermined region of a video data frame as a two-dimensional (2D) image and another region thereof as a three-dimensional (3D) image.

According to an aspect of the present invention, there is provided an image processing method including outputting a predetermined region of a current frame of video data as a two-dimensional (2D) image and another region of the current frame as a three-dimensional (3D) image by using meta data regarding the video data, wherein the meta data includes information to classify a plurality of frames, including the current frame, of the video data into predetermined units.

According to an aspect of the present invention, the information to classify the plurality of frames of the video data into the predetermined units may include shot information to classify a group of frames having similar background compositions into one shot, such that the background composition of a frame, of the group of frames, is predictable by using a previous frame, of the group of frames, preceding the frame.

According to an aspect of the present invention, the shot information may include information regarding a time when a first frame is to be output and/or information regarding a time when a last frame is to be output from among the group of frames classified into the one shot.

According to an aspect of the present invention, the shot information may include information regarding a time when the current frame having the predetermined region is to be output as the 2D image.

According to an aspect of the present invention, the meta data may further include shot type information indicating whether the group of frames classified into the one shot are to be output as a 2D image or a 3D image, and if the frames are to be output as the 3D image, the outputting of the predetermined region of the frame as the 2D image and the another region as the 3D image may include outputting the predetermined region of the frame as the 2D image and the another region as the 3D image, based on the shot type information.

According to an aspect of the present invention, the method may further include: extracting 2D display identification information from the meta data; and identifying the predetermined region that is to be output as the 2D image, based on the 2D display identification information.

According to an aspect of the present invention, the 2D display identification information may include coordinates to identify the predetermined region.

According to an aspect of the present invention, the outputting of the predetermined region as the 2D image and the another region as the 3D image may include estimating a motion of the another region by using a previous frame preceding the current frame, and generating a partial frame for the another region by using the estimated motion; generating a new frame including the predetermined region of the current frame and the partial frame; and generating an image for a left eye and an image for a right eye by using the current frame and the new frame, wherein the image for the left eye and the image for the right eye are the same for the predetermined region.

According to an aspect of the present invention, the outputting of the predetermined region as the 2D image and the another region as the 3D image may include: extracting depth information for a background and depth information for an object from the meta data; generating a depth map regarding a background included in the frame by using the depth information for the background; generating a 2D object depth map regarding the predetermined region by using the depth information for the object; and generating a depth map regarding the current frame by using the depth map regarding the background and the 2D object depth map.

According to an aspect of the present invention, the generating of the depth map regarding the current frame may include generating a depth map regarding a background of the another of the current frame.

According to an aspect of the present invention, the generating of the 2D object depth map may include: extracting a panel position value indicating a depth value of a screen from the depth information for a background; extracting coordinates of the predetermined region from the depth information for the object; and generating the 2D object depth map so that a depth value of the predetermined region is equal to the panel position value.

According to an aspect of the present invention, the depth information for the object may include information regarding a mask on which the predetermined region is indicated.

According to an aspect of the present invention, the generating of the depth map regarding the background may include generating the depth map for the background by using coordinates of the background, a depth value of the background corresponding to the coordinates, and a panel position value indicating a depth value of a screen, which are included in the depth information for the background.

According to an aspect of the present invention, the method may further include reading the meta data from a disc storing the video data or downloading the meta data from a server via a communication network.

According to an aspect of the present invention, the meta data may include identification information to identify the video data, wherein the identification information may include: a disc identifier to identify a disc storing the video data; and a title identifier to identify a number of a title including the video data from among titles recorded on the disc.

According to another aspect of the present invention, there is provided an image processing apparatus to output a predetermined region of frames of video data as a two-dimensional (2D) image and other regions of the video data as a three-dimensional (3D) image by using meta data regarding the video data, wherein the meta data includes information to classify the frames of the video data into predetermined units.

According to another aspect of the present invention, there is provided a computer readable recording medium having recorded thereon a computer program to execute an image processing method, the method including outputting a predetermined region of a current frame of video data as a two-dimensional (2D) image and another region of the current frame as a three-dimensional (3D) image by using meta data regarding the video data, wherein the meta data includes information to classify the frames of the video data into predetermined units.

According to another aspect of the present invention, there is provided a meta data transmitting method performed by a server communicating with an image processing apparatus via a communication network, the method including: receiving, by the server, a request for meta data regarding video data from the image processing apparatus; and transmitting, by the server, the meta data to the image processing apparatus, in response to the request, wherein the meta data includes depth information for a background and depth information for an object, the depth information for the background includes coordinates of the background and depth values corresponding to the coordinates, and the depth information for the object includes coordinates of a region of a two-dimensional (2D) object, and a depth value of the 2D object is equal to a panel position value.

According to another aspect of the present invention, there is provided a server communicating with an image processing apparatus via a communication network, the server including: a transceiver to receive a request for meta data regarding video data from the image processing apparatus and to transmit the meta data to the image processing apparatus, in response to the request; and a meta data storage unit to store the meta data, wherein the meta data includes depth information for a background and depth information for an object, the depth information for the background includes coordinates of the background and depth values corresponding to the coordinates, and the depth information for the object includes coordinates of a region of a two-dimensional (2D) object, and a depth value of the 2D object is equal to a panel position value.

According to yet another aspect of the present invention, there is provided a method of outputting a predetermined region of a frame of video data as a two-dimensional (2D) image and another region of the frame as a three-dimensional (3D) image by using meta data regarding the video data, the method including: extracting depth information for a background of the frame and depth information for an object of the frame from the meta data; generating a depth map regarding the background of the frame by using the depth information for the background; generating a 2D object depth map regarding the predetermined region by using the depth information for the object; and generating a depth map regarding the frame by using the depth map regarding the background and the 2D object depth map.

According to still another aspect of the present invention, there is provided a method of outputting a predetermined region of a frame of video data as a two-dimensional (2D) image and another region of the frame as a three-dimensional (3D) image by using meta data regarding the video data, the method including: extracting 2D display identification information from the meta data; identifying the predetermined region to be output as the 2D image based on the 2D display identification information; estimating a motion of the another region of a current frame by using a previous frame that precedes the current frame, and generating a partial frame for the another region by using the estimated motion; generating a new frame including the identified predetermined region of the current frame and the generated partial frame; and generating an image for a left eye and an image for a right eye by using the current frame and the new frame, wherein the image for the left eye and the image for the right eye are a same image for the predetermined region.

According to another aspect of the present invention, there is provided a computer-readable recording medium implemented by an image processing apparatus, the computer-readable recording medium including: meta data regarding video data and identifying a predetermined region of a frame of the video data as a two-dimensional (2D) image, such that the meta data is used by the image processing apparatus to output the predetermined region as the 2D image and another region of the frame as a three-dimensional (3D) image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate structures of meta data regarding video data according to embodiments of the present invention;

FIG. 2 is a view of a frame, a region of which is output as a two-dimensional (2D) image and another region of which is output as a three-dimensional (3D) image according to an embodiment of the present invention;

FIGS. 3A and 3B respectively illustrate a diagram and a graph to explain depth information according to an embodiment of the present invention;

FIG. 4 is a block diagram of an image processing system to perform an image processing method using the meta data illustrated in FIG. 1A according to an embodiment of the present invention;

FIG. 5 is a block diagram illustrating in detail a depth map generation unit of FIG. 4 according to an embodiment of the present invention;

FIG. 6 is a block diagram of an image processing system to perform an image processing method using the meta data illustrated in FIG. 1B according to another embodiment of the present invention; and

FIG. 7 is a flowchart illustrating an image processing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

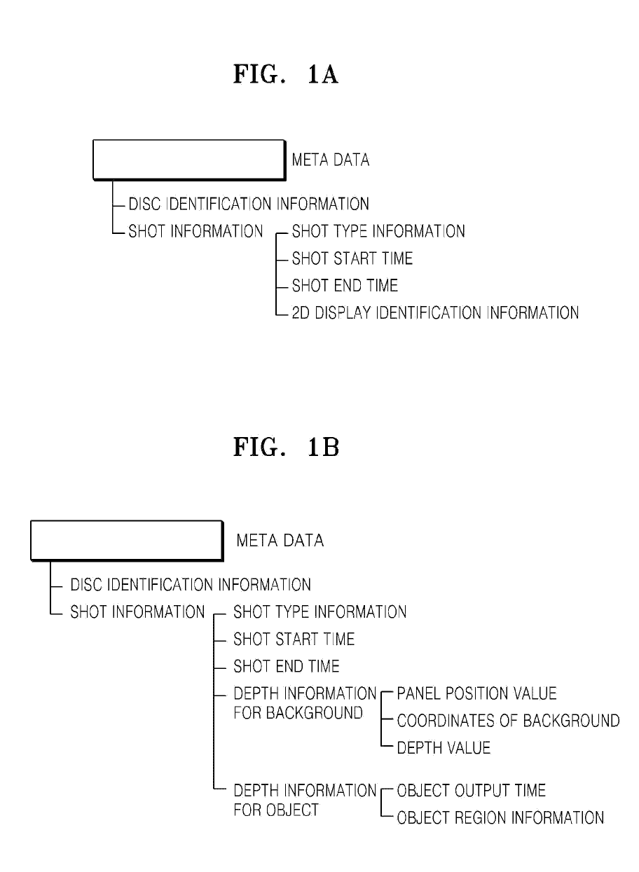

FIGS. 1A and 1B illustrate structures of meta data regarding video data according to embodiments of the present invention. The meta data according to an embodiment of the present invention contains information regarding the video data. Specifically, the meta data includes disc identification information identifying the video data so as to indicate the type of the video data. The disc identification information includes a disc identifier identifying a disc having recorded thereon the video data, and a title identifier identifying a number of a title related to the video data from among titles recorded on the disc identified by the disc identifier.

The video data includes of a series of frames, and the meta data includes information regarding the frames. The information regarding the frames includes information to classify the frames according to a predetermined criterion. For example, assuming that a group of a series of similar frames is one unit, the frames of the video data may be classified into a plurality of units. According to an embodiment of the present invention, the meta data includes information to classify the frames of the video data into predetermined units. For example, in one embodiment of the present invention, a shot refers to a group of frames having similar background compositions in which a background composition of a current frame can be predicted by using a previous frame preceding the current frame. The meta data includes information to classify the frames of the video data into shots. Hereinafter, information regarding a shot, which is included in the meta data, will be referred to as “shot information.” If the compositions of frames are remarkably changed such that the composition of a current frame is different from that of a previous frame, the current frame and the previous frame are classified into different shots. The shot information is stored in the meta data.

The shot information includes a shot start time and a shot end time. The shot start time refers to a time when a first frame is output from among frames classified as a predetermined shot and the shot end time refers to a time when a last frame is output from among the frames. While not required in all aspects, the shot information further includes the shown shot type information regarding the frames classified as the shot. The shot type information indicates for each shot whether the frames are to be output as a two-dimensional (2D) image or as a three-dimensional (3D) image. For example, video data frames can include frames containing only information, such as a warning sentence, a menu screen, and an ending credit, that is not to be three-dimensionally displayed. Accordingly, the meta data includes shot type information instructing that an image processing apparatus (not shown) output such frames as a 2D image without converting the frames into a 3D image. It is understood that the meta data can be otherwise constructed, such as when the shot duration is expressed instead of or in addition to one of the shot start or end information.

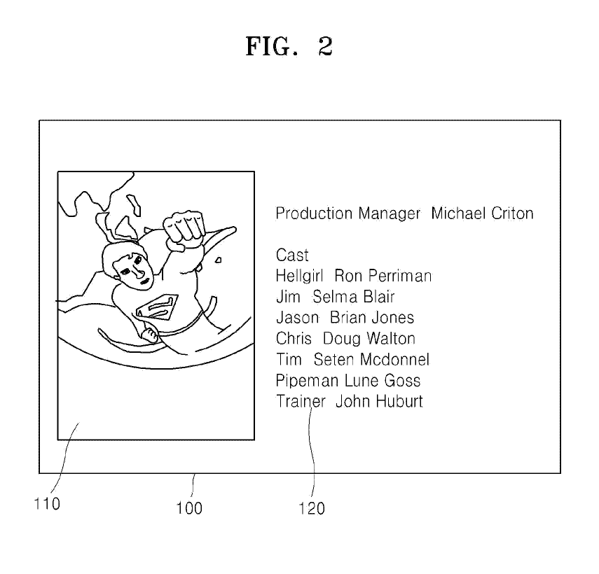

However, some of the frames that are to be output as a 3D image may include a region that is not to be output as a 3D image (e.g., an ending credit). Such a frame will now be described with reference to FIG. 2. FIG. 2 is a view of a frame 100, a region 120 of which is output as a 2D image and another region 110 of which is output as a 3D image according to an embodiment of the present invention. Referring to FIG. 2, the frame 100 includes both the first region 120 that is to be output as a 2D image and the second region 110 that is to be output as a 3D image. As illustrated in FIG. 2, when the frame 100 includes the first region 120, such as the ending credit that is not to be output as a 3D image, meta data further includes information indicating the region 120 to be output as a 2D image, so that an image processing unit (not shown) may output the first region 120 of the frame 100 as a 2D image rather than a 3D image. However, it is understood that the meta data need not always include such information.

Methods of converting a 2D image into a 3D image include a method of predicting a motion of a current frame from that of a previous frame and then outputting the current frame as a 3D image by using the predicted motion of the current frame, and a method of generating a depth map regarding a frame by using the composition of the frame and then adding a sense of depth to the frame based on the depth map. In an embodiment of the present invention, information instructing an image processing apparatus to output a predetermined region of a frame as a 2D image is included in meta data in a format selected according to the conversion method used, of the above two methods.

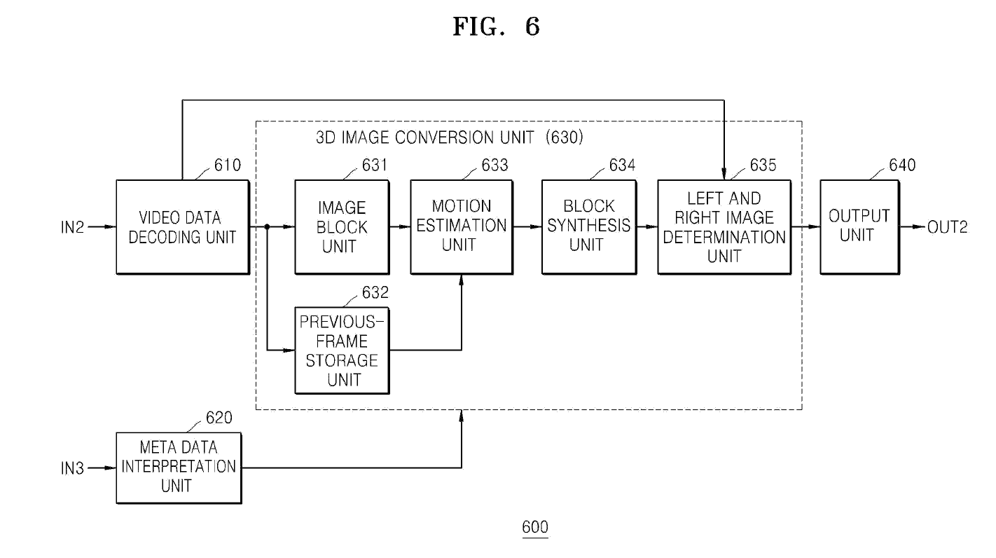

FIG. 1A illustrates meta data used when a 2D image is converted into a 3D image by predicting a motion of a current frame from that of a previous frame. Referring to FIG. 1A, the meta data includes 2D display identification information to instruct an image processing apparatus to output a predetermined region of a frame as a 2D image. The 2D display identification information identifies the predetermined region of the frame to be output as the 2D image. For example, the 2D display identification information may include coordinates of the predetermined region of the frame to be output as the 2D image. A method of outputting a 2D image as a 3D image through motion estimation between frames will be described later in detail with reference to FIG. 6.

FIG. 1B illustrates meta data used when a depth map regarding a frame is generated using the composition of the frame and then a sense of depth is added to the frame based on the depth map. Referring to FIG. 1B, the meta data includes depth information. The depth information allows a sense of depth to be added to a frame in order to convert a 2D image into a 3D image and is classified into depth information for a background and depth information for an object. In detail, an image of one frame may include an image of a background, and an image of something else other than the background (i.e., an image of an object). Depth information for a background is information to add a sense of depth to a background image. Adding a sense of depth to the background image allows the background image to be represented as a 3D (stereoscopic) image by adding a sense of depth to the composition (such as arrangement and/or structure) of the background.

Since background compositions of frames may vary, depth information for a background of each shot included in meta data includes composition type information indicating the composition of the background from among a plurality of compositions. While not required in all aspects, the shown depth information for a background includes the coordinates of the background, depth values of the background corresponding to the coordinates, and a panel position value. The coordinates of the background are coordinates of the background included in a frame of a 2D image. The depth values indicate the degree of depth to be added to the 2D image. The meta data includes depth values to be assigned to respective coordinates of frames of the 2D image. The panel position is a location on a screen on which an image is displayed, and the panel position value is a depth value of the screen.

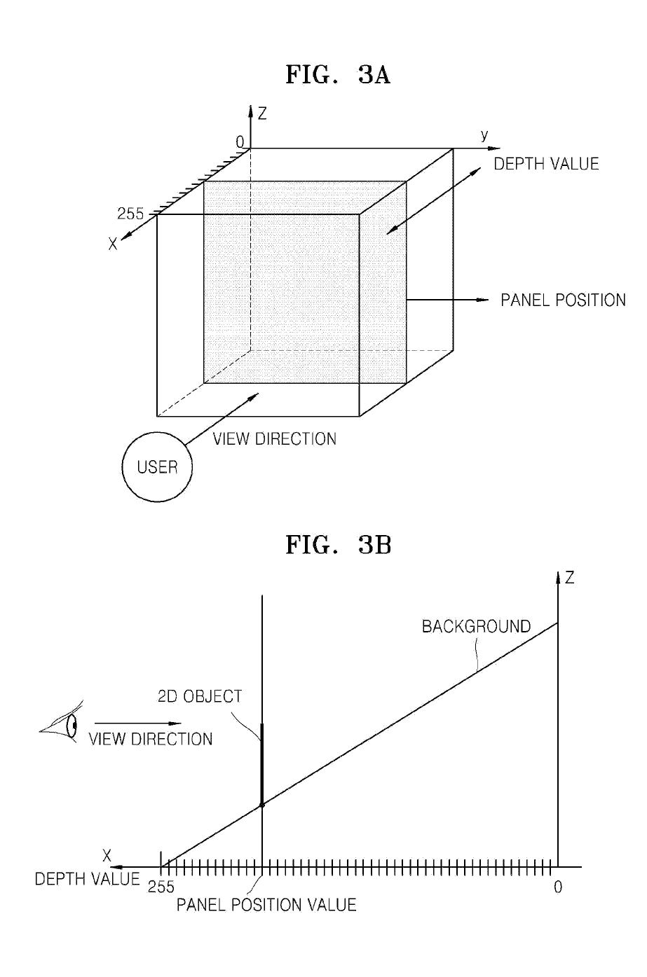

The depth information for an object is information to add a sense of depth to a subject except for a background, such as people or a building standing vertically (hereinafter referred to as an “object”). In an embodiment of the present invention, an object is used to indicate a region of a frame to be two-dimensionally output. The depth information for an object includes object output time and object region information. The object output time is a time to output a frame including the region to be two-dimensionally output. The object region information is information indicating an object region and may include coordinates of the object region to be two-dimensionally output. In some cases, a mask on which the object region to be two-dimensionally output is indicated may be used as the object region information. The depth information for a background and the depth information for an object will be described later in detail with reference to FIGS. 3 through 5.

As described above, according to an embodiment of the present invention, meta data includes information to convert 2D video data into a 3D image, and information indicating a predetermined region of a frame to be output as a 2D image and/or the other region of the frame to be output as a 3D image.

FIGS. 3A and 3B illustrate a diagram and a graph to explain depth information according to an embodiment of the present invention. FIG. 3A is a diagram illustrating a sense of depth added to an image according to an embodiment of the present invention. FIG. 3B is a graph illustrating a sense of depth added to an image when the image is viewed from a lateral side of a screen on which the image is projected according to an embodiment of the present invention.

A sense of depth is added to a 2D image so that the 2D image is three-dimensionally represented. When a person views a screen, an image projected onto the screen is focused on the person's two eyes, and the distance between two images focused on the two eyes is referred to as “parallax.” Parallax is classified into positive parallax, zero parallax, and negative parallax. Positive parallax occurs when an image is inwardly focused on a screen, and is less than or equal to the distance between the eyes. The greater the parallax, the greater a sense of stereoscopic vision produced, as if the depth of the image is greater than that of a screen. When an image is two-dimensionally focused on a screen plane, parallax is zero. If the parallax is zero, the image is focused on the screen plane and thus a user does not sense a stereoscopic effect. Negative parallax occurs when an image of an object is viewed ahead of a screen. That is, negative parallax occurs when the focus of each eye intersects each other, and thus a user senses a stereoscopic effect as if the object protrudes.

Referring to FIGS. 3A and 3B, a direction of the X-axis is parallel to a direction in which a user views a screen, and denotes the degree of depth of a frame. A depth value refers to the degree of depth of an image. According to an embodiment of the present invention, the depth value may be one of 256 values (i.e., from 0 to 255), as illustrated in FIGS. 3A and 3B. The closer the depth value is to zero, the higher the degree of depth of the image and the more distant the image appears from the user. Conversely, the closer the depth value is to 255, the closer the image appears to the user.

As described above, the panel position refers to a location on a screen on which an image is focused. A panel position value is a depth value of an image when parallax is zero (i.e., when the image is focused on a surface of the screen). The panel position value may also have a depth value from 0 to 255. If the panel position value is 255, all images included in a frame may have a depth value less than or equal to that of the screen and thus are focused to be distant from a viewer (i.e., are focused at an inward location of the screen), which means that the images included in the frame have zero or positive parallax. If the panel position value is zero, all the images included in the frame may have a depth value equal to or greater than that of the screen and thus are focused as if they protrude from the screen, which means that all the images in the frame have zero or negative parallax.

In an embodiment of the present invention, an object is used to indicate a region of a frame to be output as a 2D image. Hereinafter, an object indicating a region of a frame to be output as a 2D image will be referred to as a “2D object.” When an image is focused on a screen, as illustrated in FIG. 3B, the image is displayed two-dimensionally and thus a depth value of a 2D object is equal to a panel position value. The 2D object has the panel position value as a depth value with respect to all regions of the frame, in a direction of the Z-axis (i.e., a direction parallel to the panel position).

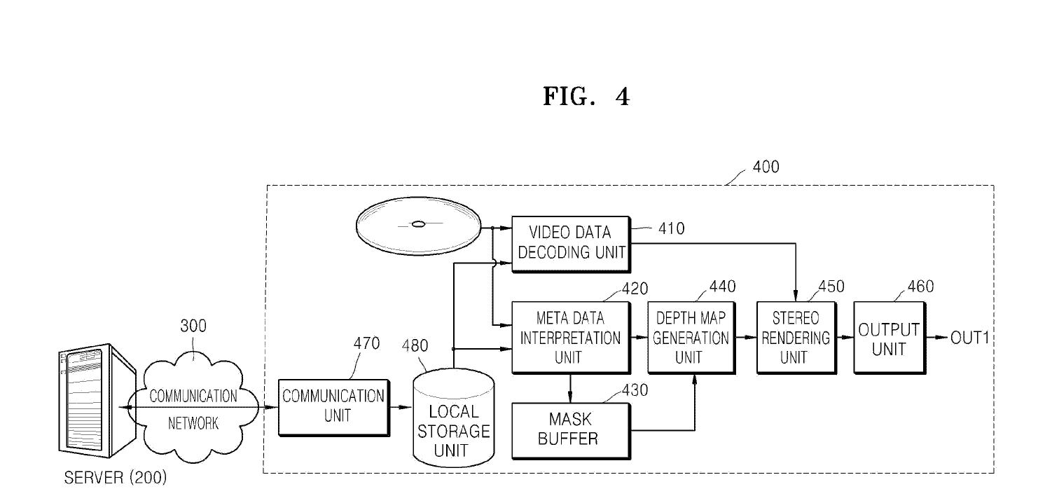

FIG. 4 is a block diagram of an image processing system to perform an image processing method by using the meta data of FIG. 1A, according to an embodiment of the present invention. Referring to FIG. 4, the image processing system includes an image processing apparatus 400, a server 200, and a communication network 300. The image processing apparatus 400 is connected to the server 200 via the communication network 300. The communication network 300 includes a wired and/or wireless communication network. However, it is understood that aspects of the present invention are not limited thereto. For example, according to other aspects, the image processing apparatus 400 may be directly connected to the server 200 via a wired and/or wireless connection (such as a universal serial bus connection, a Bluetooth connection, an infrared connection, etc.).

The image processing apparatus 400 includes a video data decoding unit 410, a meta data interpretation unit 420, a mask buffer 430, a depth map generation unit 440, a stereo rendering unit 450, a communication unit 470, a local storage unit 480, and an output unit 460 to output a 3D image produced in a 3D format to a screen (not shown). However, it is understood that in other embodiments, the image processing apparatus 400 does not include the output unit 460. Moreover, while not required, each of the units 410, 420, 430, 440, 450, 470 can be one or more processors or processing elements on one or more chips or integrated circuits.

Video data and/or meta data regarding the video data may be stored in the server 200 or may be recorded on a storage medium (such as a flash memory, an optical storage medium, etc.) (not shown), in a multiplexed form or independently. If the server 200 stores the video data and/or the meta data, the image processing apparatus 400 may download the video data and/or the meta data from the server 200 via the communication network 300. However, it is understood that the meta data and video data can be stored separately, such as where the server 200 stores the meta data and the video data is stored on a disc.

The server 200 is managed by a content provider, such as a broadcasting station or a general content production company, and stores video data and/or meta data regarding the video data. The server 200 extracts content requested by a user and provides the content to the user.

The communication unit 470 requests the server 200 to provide video data and/or meta data regarding the video data requested by a user and receives the meta data from the server 200, via the wired and/or wireless communication network 300. When the communication unit 470 performs a wireless communication technique, the communication unit 470 may include a radio-frequency signal transceiver (not shown), a base-band processor (not shown), a link controller (not shown), an IEEE 1394 interface, etc. The wireless communication technique may include wireless local area networking (WLAN), Bluetooth, Zigbee, and WiBro, etc.

The local storage unit 480 stores the meta data downloaded from the server 20 by the communication unit 470. The local storage unit 480 may be external or internal, and may be a volatile memory (such as RAM) or a non-volatile memory (such as ROM, flash memory, or a hard disk drive).

The video data decoding unit 410 and the meta data interpretation unit 420 respectively read and interpret the video data and the meta data regarding the video data, from the local storage unit 480. If the video data and/or the meta data regarding the video data is recorded on a disc (such as a DVD, Blu-ray disc, or any other optical or magnetic recording medium) or other external storage medium in a multiplexed form or independently and the disc is loaded into the image processing apparatus 400, then the video data decoding unit 410 and the meta data interpretation unit 420 respectively read the video data and the meta data from the loaded disc (or other external storage medium). The meta data may be recorded on a lead-in area, a user data area, and/or a lead-out area of the disc. When the video data is recorded on the disc, the meta data interpretation unit 420 extracts, from the meta data, a disc identifier identifying the disc storing the video data and a title identifier identifying a number of a title including the video data from among titles recorded on the disc. Accordingly, the meta data interpretation unit determines which video data is related to the meta data based on the disc identifier and the title identifier. The meta data interpretation unit 420 parses depth information for a background and depth information for an object regarding a frame by using the meta data. Also, the meta data interpretation unit 420 transmits the parsed depth information to the depth map generation unit 440. While not required, the image processing apparatus 400 can include a drive to read the disc directly, or can be connected to a separate drive.

If information regarding a mask is defined as object region information with respect to an object included in a currently output frame, the mask buffer 430 temporarily stores the mask to be applied to the frame. In the mask, all regions may have the same color except for a region corresponding to the object, and/or have a plurality of holes formed along the outline of the region corresponding to the object.

The depth map generation unit 440 generates a depth map regarding the frame by using the depth information for a background and the depth information for an object that are received from the meta data interpretation unit 420, and the mask received from the mask buffer 430. The depth map generation unit 440 produces a depth map for the background and a depth map for the object by using the meta data and combines the depth map for the background with the depth map for the object in order to produce a depth map of one frame. In detail, the depth map generation unit 440 identifies a region of a 2D object by using the object region information included in the depth information for an object. As described above, the object region information may include coordinates of the region of the 2D object. In some cases, the object region information may be a mask in which the shape of the 2D object is indicated. The depth map generation unit 440 determines the shape of the 2D object by using the coordinates and/or the mask, and produces a depth map of the 2D object by using a panel position value as a depth value of the region of the 2D object. Moreover, the depth map generation unit 440 produces the depth map for the background and combines the depth map of the background with the depth map of the object to obtain the depth map of one frame. Then the depth map generation unit 440 provides the obtained depth map to the stereo rendering unit 450.

The stereo rendering unit 450 produces an image for a left eye and an image for a right eye by using a video image received from the video data decoding unit 410 and the depth map received from the depth map generation unit 440. Accordingly, the stereo rendering unit 450 produces the image in a 3D format, including both the image for the left eye and the image for the right eye. The 3D format includes a top and down format, a side-by-side format, and an interlaced format. The stereo rendering unit 450 transmits the image in the 3D format to an output device 460. While the present embodiment includes the output device 460 in the image processing apparatus 400, it is understood that the output device may be distinct from the image processing apparatus 400 in other embodiments.

Hereinafter, a case where the output device is included as the output unit 460 in the image processing apparatus 400 will be described. The output unit 460 sequentially outputs the image for the left eye and the image for the right eye to the screen. In general, a viewer recognizes that images are sequentially, seamlessly reproduced when the images are displayed at a minimum frame rate of 60 Hz with respect to one of the viewer's eyes. Thus, if images respectively viewed with the left eye and the right eye are blended together to be recognized as a 3D image, a display device displays the images at a minimum frame rate of 120 Hz. The output unit 460 sequentially outputs the image for the left eye and the image for the right eye included in a frame at least every 1/120 of a second. The output image OUT1 can be received at a receiving unit through which a user sees the screen, such as goggles, through wired and/or wireless protocols.

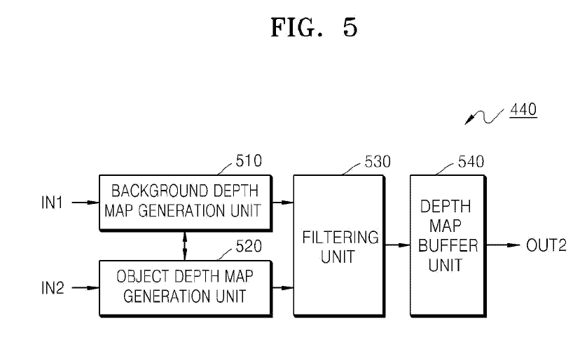

FIG. 5 is a block diagram illustrating in detail the depth map generation unit 440 of FIG. 4 according to an embodiment of the present invention. Referring to FIG. 5, the depth map generation unit 440 includes a background depth map generation unit 510, an object depth map generation unit 520, a filtering unit 530 and a depth map buffer unit 540. The background depth map generation unit 510 receives, from the meta data interpretation unit 420, type information and/or coordinates of the background, a depth value of the background corresponding to the coordinates, and a panel position value that are included in depth information for a background. Accordingly, the background depth generation unit 510 generates a depth map for the background based on the received information. The background depth map generation unit 510 provides the depth map for the background to the filtering unit 530.

The object depth map generation unit 520 receives, from the meta data interpretation unit 420, object region information included in depth information for an object, and generates a depth map for the object based on the received information. If the object region information is related to a mask, the object depth map generation unit 520 receives a mask to be applied to a frame to be output from the mask buffer 430 and produces a depth map of the object by using the mask. Moreover, the object depth map generation unit 520 produces a depth map regarding a 2D object by using a panel position value as a depth value of the 2D object. The object depth map generation unit 520 provides the depth map for the 2D object to the filtering unit 530.

The filtering unit 530 filters the depth map for the background and the depth map for the object. A region of a 2D object has a same depth value. If the 2D object region occupies a large part in the frame, the filtering unit 530 may apply a filter to give a sense of stereoscopy to the 2D object. If the depth map for the background is a plane (i.e., if all depth values of the background are panel position values), a filter may also be applied to achieve a stereoscopic effect for the background.

The depth map buffer unit 540 temporarily stores the depth map for the background, which passes through the filtering unit 530, and adds the depth map for the object to the depth map for the background to update the depth map for the frame when the depth map for the object is generated. If the depth map for the frame is obtained, the depth map buffer unit 540 provides the depth map for the frame to the stereo rendering unit 450 in FIG. 4.

FIG. 6 is a block diagram of an image processing apparatus 600 to perform an image processing method using the meta data of FIG. 1B according to another aspect of the present invention. Referring to FIG. 6, the image processing apparatus 600 includes a video data decoding unit 610, a meta data interpretation unit 620, and a 3D image conversion unit 630, and an output unit 640 to output a 3D image produced in a 3D format to a screen (not shown). However, it is understood that in other embodiments, the image processing apparatus 400 does not include the output unit 460. Although not show in FIG. 6, the image processing apparatus 600 may further include a communication unit and a local storage unit as illustrated in FIG. 4. In this case, the image processing apparatus 600 can download video data and meta data regarding the video data from an external server via the communication unit. Moreover, while not required, each of the units 610, 620, and 630 can be one or more processors or processing elements on one or more chips or integrated circuits.

If the video data and/or the meta data regarding the video data are downloaded from a server (not shown) in a multiplexed form or independently via the communication unit and are stored in the local storage, the video data decoding unit 610 and the meta data interpretation unit 620 may read the downloaded data from the local storage unit, and use the read data. If the video data and/or the meta data regarding the video data are recorded on a disc (not shown) or other external storage medium (such as a flash memory) in a multiplexed form or independently, when the disc or other external storage medium is loaded into the image processing apparatus 600, the video data decoding unit 610 and the meta data interpretation unit 620 respectively read the video data and the meta data from the loaded disc. The meta data may be recorded on a lead-in area, a user data area, and/or a lead-out area of the disc. While not required, the image processing apparatus 600 can include a drive to read the disc directly, or can be connected to a separate drive.

The meta data interpretation unit 620 extracts information regarding frames from the meta data and interprets the extracted information. If the video data is recorded on the disc, the meta data interpretation unit 620 extracts, from the meta data, a disc identifier identifying the disc storing the video data and a title identifier identifying a number of a title including the video data from among titles recorded on the disc. Accordingly, the meta data interpretation unit 620 determines the video data related to the meta data by using the disc identifier and the title identifier.

The meta data interpretation unit 620 extracts shot information from the meta data and controls the 3D image conversion unit 630 by using the shot information. Specifically, the meta data interpretation unit 620 extracts shot type information from the shot information and determines whether to output frames belonging to one shot as a 2D image or a 3D image, based on the shot type information. If the meta data interpretation unit 620 determines, based on the shot type information, that video data categorized into a predetermined shot is not to be converted into a 3D image, the meta data interpretation unit 620 controls the 3D image conversion unit 630 so that the 3D image conversion unit 630 does not estimate a motion of a current frame by using a previous frame. If the meta data interpretation unit 620 determines, based on the shot type information, that the video data categorized into the predetermined shot is to be converted into a 3D image, the meta data interpretation unit 620 controls the 3D image conversion unit 630 to convert the current frame into a 3D image by using the previous frame. If the video data categorized into the predetermined shot is to be output as a 3D image, the 3D image conversion unit 630 converts video data of a 2D image received from the video data decoding unit 610 into a 3D image.

If frames categorized into a predetermined shot are to be output as a 3D image, the meta data interpretation unit 620 further extracts, from the meta data, information regarding time when a frame including a region to be output as a 2D image is to be output. Also, the meta data interpretation unit 620 extracts 2D display identification information to identify the region to be output as a 2D image. As described above, the 2D display identification information may be coordinates to identify the region to be output as a 2D image.

The 3D image conversion unit 630 includes an image block unit 631, a previous-frame storage unit 632, a motion estimation unit 633, a block synthesis unit 634, and a left and right image determination unit 635. The image block unit 631 divides a frame of video data of a 2D image into predetermined sized blocks. The previous-frame storage unit 632 stores a predetermined number of previous frames in relation to a current frame.

The motion estimation unit 633 calculates the degree of a motion and the direction of the motion and produces a motion vector with respect to each of the divided blocks of the current frame using blocks of the current frame and blocks of the previous frames. If the current frame is to be output as a 2D image, the motion estimation unit 633 directly transmits the current frame to the block synthesis unit 634 without referring to previous frames thereof. If a frame is to be output as a 3D image includes a region that is to be output as a 2D image, the motion estimation unit 633 estimates motions of the regions of the frame other than the region that is to be output as a 2D image.

The block synthesis unit 634 generates a new frame by synthesizing blocks that are selected from among predetermined blocks of the previous frames by using the motion vector. If a current frame has a region that is to be output as a 2D image, the block synthesis unit 634 generates a new frame by applying predetermined blocks of the original current frame included in a region that is to be output as a 2D image.

The new frame is provided to the left and right image determination unit 635. The left and right image determination unit 635 determines an image for a left eye and an image for a right eye by using the new frame received from the block synthesis unit 634 and a frame received from the video data decoding unit 610. If a frame is to be output as a 2D image, the left and right image determination unit 635 generates the same image for left and right eyes by using a frame of a 2D image received from the block synthesis unit 634 and a 2D image received from the video data decoding unit 610. If a frame has a region that is to be output as a 2D image from among frames that are to be output as a 3D image, an image for a left eye and an image for a right image that are generated by the left and right image determination unit 635 are the same for the region that is to be output as a 2D image. The left and right image determination unit 635 transmits the image for the left eye and the image for the right image to the output unit 640. The output unit 640 alternately displays the image for the left eye and the image for the right eye determined by the left and right image determination unit 635 at least every 1/120 seconds.

As described above, the image processing apparatus 600 according to an embodiment of the present invention identifies a region of frames to be output as a 2D image, based on shot information included in meta data, and outputs the identified region as a 2D image.

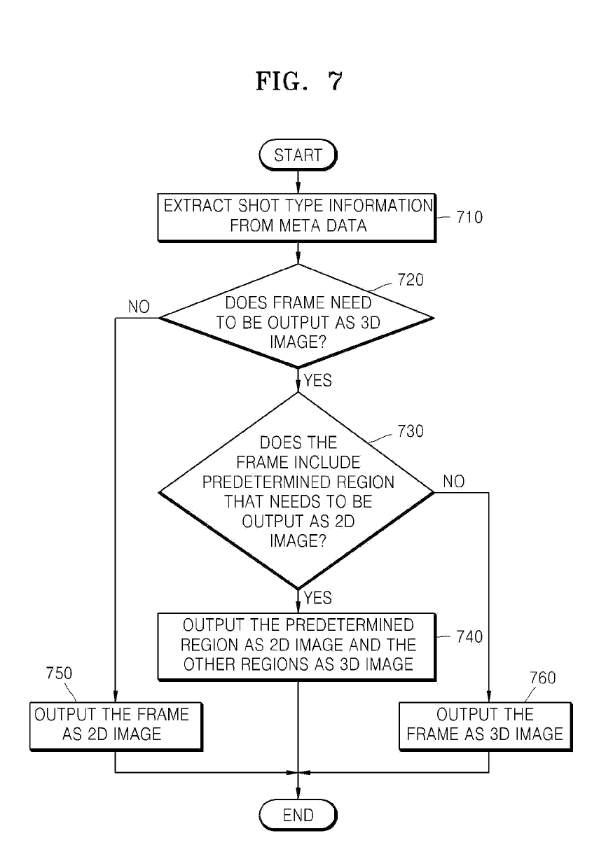

FIG. 7 is a flowchart illustrating an image processing method according to an embodiment of the present invention. Referring to FIG. 7, an image processing apparatus 400 or 600 extracts shot type information from meta data in operation 710. The image processing apparatus 400 or 600 determines whether frames classified into a predetermined shot are to be output as a 2D image or a 3D image, based on the extracted shot type information in operation 720. If it is determined, based on the extracted shot type information, that the frames classified as the predetermined shot are to be output as a 2D image (operation 720), the image processing apparatus outputs the frames as a 2D image in operation 750. If the frames are determined to be output as a 3D image (operation 720), the image processing apparatus 400 or 600 determines whether the frames have a predetermined region that is to be output as a 2D image in operation 730.

If it is determined, based on the extracted shot type information, that the frames classified as the predetermined shot are to be output as a 3D image (operation 720) and the frames have a predetermined region that is to be output as a 2D image (operation 730), the image processing apparatus 400 or 600 outputs the predetermined region as a 2D image and the other regions as a 3D image in operation 740. Conversely, if it is determined, based on the extracted shot type information, that the frames classified as the predetermined shot are to be output as a 3D image (operation 720) and the frames do not have a predetermined region that is to be output as a 2D image (operation 730), then the image processing apparatus 400 or 600 outputs all regions of the frames as a 3D image in operation 760.

According to the above embodiments, an image processing method and apparatus are capable of outputting a predetermined region of a video data frame as a 2D image and the other regions thereof as a 3D image. While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet. Moreover, while not required in all aspects, one or more units of the image processing apparatus 400 or 600 can include a processor or microprocessor executing a computer program stored in a computer-readable medium, such as the local storage unit 480.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image processing method of an image processing apparatus, the image processing method comprising:
analyzing, by the image processing apparatus, meta data comprising information to classify a plurality of frames, including a current frame, of video data into predetermined units to determine a predetermined region of the current frame to be output as a two-dimensional (2D) image; and
outputting, by the image processing apparatus, the predetermined region of the current frame of the video data as the 2D image and another region of the current frame as a three-dimensional (3D) image by using the analyzed meta data.

2. The method as claimed in claim 1, wherein:
the information to classify the plurality of frames of the video data into the predetermined units comprises shot information to classify a group of frames having similar background compositions into one shot, such that the background composition of a frame, of the group of frames, is predictable by using a previous frame, of the group of frames, preceding the frame; and
the group of frames comprises the current frame.

3. The method as claimed in claim 2, wherein the shot information comprises information regarding a time when a first frame is to be output and/or information regarding a time when a last frame is to be output from among the group of frames classified into the one shot.

4. The method as claimed in claim 3, wherein the shot information further comprises information regarding a time when the current frame having the predetermined region is to be output.

5. The method as claimed in claim 2, wherein:
the meta data further comprises shot type information indicating whether the group of frames classified into the one shot are to be output as a 2D image or a 3D image; and
the outputting of the predetermined region of the current frame as the 2D image and the another region as the 3D image comprises:
when the group of frames are to be output as the 3D image, outputting the predetermined region of the current frame as the 2D image and the another region as the 3D image based on the shot type information, and
when the group of frames are to be output as the 2D image, outputting the predetermined region of the current frame as the 2D image and the another region as the 2D image.

6. The method as claimed in claim 1, further comprising:
extracting 2D display identification information from the meta data; and
identifying the predetermined region to be output as the 2D image based on the 2D display identification information.

7. The method as claimed in claim 6, wherein the 2D display identification information comprises coordinates to identify the predetermined region.

8. The method as claimed in claim 6, wherein the outputting of the predetermined region as the 2D image and the another region as the 3D image comprises:
estimating a motion of the another region of the current frame by using a previous frame that precedes the current frame, and generating a partial frame for the another region by using the estimated motion;
generating a new frame including the predetermined region of the current frame and the generated partial frame; and
generating an image for a left eye and an image for a right eye by using the current frame and the generated new frame, and
wherein the image for the left eye and the image for the right eye comprise a same image for the predetermined region, but different images for the another region.

9. The method as claimed in claim 1, wherein the outputting of the predetermined region as the 2D image and the another region as the 3D image comprises:
extracting depth information for a background of the current frame and depth information for an object of the current frame from the meta data;
generating a depth map regarding the background of the current frame by using the depth information for the background;
generating a 2D object depth map regarding the predetermined region by using the depth information for the object; and
generating a depth map regarding the current frame by using the depth map regarding the background and the 2D object depth map.

10. The method as claimed in claim 9, wherein the generating of the depth map regarding the current frame comprises generating a depth map regarding a background of the another region of the current frame.

11. The method as claimed in claim 9, wherein the generating of the 2D object depth map comprises:
extracting a panel position value indicating a depth value of a screen from the depth information for the background;
extracting coordinates of the predetermined region from the depth information for the object; and
generating the 2D object depth map so that a depth value of the predetermined region is equal to the panel position value.

12. The method as claimed in claim 9, wherein the depth information for the object comprises information regarding a mask on which the predetermined region is indicated.

13. The method as claimed in claim 9, wherein the generating of the depth map regarding the background comprises generating the depth map regarding the background by using coordinates of the background, depth values of the background corresponding to the coordinates, and a panel position value indicating a depth value of a screen, which are included in the depth information for the background.

14. The method as claimed in claim 1, further comprising reading the meta data from a disc storing the video data or downloading the meta data from a server via a communication network.

15. The method as claimed in claim 1, wherein:
the meta data comprises identification information to identify the video data; and
the identification information comprises:
a disc identifier to identify a disc storing the video data; and
a title identifier to identify a number of a title including the video data from among titles recorded on the disc.

16. An image processing apparatus comprising:
a meta data interpretation unit to interpret meta data to determine a predetermined region of a current frame of video data to be output as a two-dimensional (2D) image; and
an output unit to output the determined predetermined region of the current frame as the 2D image and another region of the current frame as a three-dimensional (3D) image,
wherein the meta data comprises information to classify a plurality of frames, including the current frame, of the video data into predetermined units.

17. The apparatus as claimed in claim 16, wherein:
the information to classify the plurality of frames of the video data into the predetermined units comprises shot information to classify a group of frames having similar background compositions into one shot, such that the background composition of a frame, of the group of frames, is predictable by using a previous frame, of the group of frames, preceding the frame; and
the group of frames comprises the current frame.

18. The apparatus as claimed in claim 17, wherein the shot information comprises information regarding a time when a first frame is to be output and/or information regarding a time when a last frame is to be output from among the group of frames classified into the one shot.

19. The apparatus as claimed in claim 18, wherein the shot information further comprises information regarding a time when the current frame having the predetermined region is to be output.

20. The apparatus as claimed in claim 17, wherein:
the meta data further comprises shot type information indicating whether the group of frames classified into one shot are to be output as a 2D image or a 3D image;
when the group of frames are to be output as the 3D image, the output unit outputs the predetermined region of the current frame as the 2D image and the another region as the 3D image, based on the shot type information; and
when the group of frames are to be output as the 2D image, the output unit outputs the predetermined region of the current frame as the 2D image and the another region as the 2D image, based on the shot type information.

21. The apparatus as claimed in claim 16, wherein the meta data interpretation unit extracts 2D display identification information from the meta data, and determines the predetermined region that is to be output as the 2D image based on the 2D display identification information.

22. The apparatus as claimed in claim 21, wherein the 2D display identification information comprises coordinates to identify the predetermined region.

23. The apparatus as claimed in claim 21, further comprising:
a 3D image conversion unit to estimate a motion of the another region of the current frame by using a previous frame that precedes the current frame, to generate a partial frame for the another region by using the estimated motion, to generate a new frame including the predetermined region of the current frame and the generated partial frame, and to generate an image for a left eye and an image for a right eye by using the current frame and the new frame,
wherein the image for the left eye and the image for the right eye are a same image for the predetermined region and are not the same for the another region, and the output unit outputs the image for the left eye and the image for the right eye.

24. The apparatus as claimed in claim 16, further comprising:
a depth map generation unit to generate a depth map regarding a background of the current frame by using depth information for the background, to generate a 2D object depth map regarding the predetermined region by using depth information for an object of the current frame, and to generate a depth map regarding the current frame by using the depth map regarding the background and the 2D object depth map,
wherein the meta data interpretation unit extracts the depth information for the background and the depth information for the object from the meta data.

25. The apparatus as claimed in claim 24, wherein the depth map generation unit generates a depth map regarding a background of the another regions of the current frame.

26. The apparatus as claimed in claim 24, wherein:
the depth information for the background comprises a panel position value indicating a depth value of a screen;
the depth information for the object comprises coordinates of the predetermined region; and
the depth map generation unit generates the 2D object depth map so that a depth value of the predetermined region is equal to the panel position value.

27. The apparatus as claimed in claim 24, wherein the depth information for the object comprises information regarding a mask on which the predetermined region is indicated.

28. The apparatus as claimed in claim 24, wherein:
the depth information for the background comprises coordinates of the background, depth values of the background corresponding to the coordinates, and a panel position value indicating a depth value of a screen; and
the depth map generation unit generates the depth map for the background by using the coordinates of the background, the depth values of the background, and the panel position value.

29. The apparatus as claimed in claim 16, wherein the meta data is read from a disc storing the video data or is downloaded from a server via a communication network.

30. The apparatus as claimed in claim 16, wherein:
the meta data comprises identification information to identify the video data; and
the identification information comprises:
a disc identifier to identify a disc storing the video data; and
a title identifier to identify a number of a title including the video data from among titles recorded on the disc.

31. A computer readable recording medium having recorded thereon a computer program to execute the image processing method of claim 1 and implemented by an image processing apparatus.

32. A meta data transmitting method performed by a server communicating with an image processing apparatus via a communication network, the method comprising:
receiving, by the server, a request for meta data regarding video data from the image processing apparatus; and
transmitting, by the server, the meta data to the image processing apparatus, in response to the request,
wherein the meta data comprises depth information for a background of a frame of the video data and depth information for an object of the frame,
the depth information for the background comprises coordinates of the background, depth values corresponding to the coordinates, and a panel position value indicating a depth value of an output screen,
the depth information for the object comprises coordinates of a region of a two-dimensional (2D) object in the frame, and the image processing apparatus outputs the region of the 2D object as a 2D image and the background as a 3D image according to the received meta data, and
a depth value of the 2D object is equal to the panel position value.

33. A computer-readable recording medium encoded with the method of claim 32 and implemented by at least one computer.

34. A server communicating with an image processing apparatus via a communication network, the server comprising:
a transceiver to receive a request for meta data regarding video data from the image processing apparatus and transmitting the requested meta data to the image processing apparatus, in response to the request; and
a meta data storage unit to store the meta data,
wherein the meta data comprises depth information for a background of a frame of the video data and depth information for an object of the frame,
the depth information for the background comprises coordinates of the background, depth values corresponding to the coordinates, and a panel position value indicating a depth value of an output screen,
the depth information for the object comprises coordinates of a region of a two-dimensional (2D) object in the frame used by the image processing apparatus to output the region in 2D and another region in 3D, and
a depth value of the 2D object is equal to the panel position value.

35. A method of outputting a predetermined region of a frame of video data as a two-dimensional (2D) image and another region of the frame as a three-dimensional (3D) image by using meta data regarding the video data, the method comprising:
extracting depth information for a background of the frame and depth information for an object of the frame from the meta data;
generating a depth map regarding the background of the frame by using the depth information for the background;
generating a 2D object depth map regarding the predetermined region by using the depth information for the object; and
generating a depth map regarding the frame by using the depth map regarding the background and the 2D object depth map.

36. The method as claimed in claim 35, wherein the generating of the depth map regarding the frame comprises generating a depth map regarding a background of the another region of the frame.

37. The method as claimed in claim 35, wherein the generating of the 2D object depth map comprises:
extracting a panel position value indicating a depth value of a screen from the depth information for the background;
extracting coordinates of the predetermined region from the depth information for the object; and
generating the 2D object depth map so that a depth value of the predetermined region is equal to the panel position value.

38. A computer-readable recording medium encoded with the method of claim 35 and implemented by at least one computer.

39. A method of outputting a predetermined region of a frame of video data as a two-dimensional (2D) image and another region of the frame as a three-dimensional (3D) image by using meta data regarding the video data, the method comprising:
extracting 2D display identification information from the meta data;
identifying the predetermined region to be output as the 2D image based on the 2D display identification information;
estimating a motion of the another region of a current frame by using a previous frame that precedes the current frame, and generating a partial frame for the another region by using the estimated motion;
generating a new frame including the identified predetermined region of the current frame and the generated partial frame; and
generating an image for a left eye and an image for a right eye by using the current frame and the new frame,
wherein the image for the left eye and the image for the right eye are a same image for the predetermined region.

40. A computer-readable recording medium encoded with the method of claim 39 and implemented by at least one computer.

41. A computer-readable recording medium implemented by an image processing apparatus, the computer-readable recording medium comprising:
meta data regarding video data and indicating to the image processing apparatus a predetermined region of a frame of the video data as a two-dimensional (2D) image, such that the meta data is used by the image processing apparatus to detect and output the predetermined region as the 2D image and another region of the frame as a three-dimensional (3D) image.

42. The computer-readable recording medium as claimed in claim 41, wherein:
the meta data comprises depth information for a background of the frame and depth information for an object of the frame;
the depth information for the background comprises coordinates of the background, depth values corresponding to the coordinates to enable the image processing apparatus to output the another region as the 3D image, and a panel position value indicating a depth value of an output screen and is used by the image processing apparatus to output the predetermined region as the 2D object as a depth value of the 2D object is equal to the panel position value; and
the depth information for the object comprises coordinates of the predetermined region in the frame.
